(19) United States
(12) Patent Application Publication
(10) Pub. No.: US 2021/0041123 A1
(43) Pub. Date: Feb. 11, 2021

(54) REFRIGERATION CYCLE SYSTEM

(71) Applicant: Hitachi-Johnson Controls Air Conditioning, Inc., Tokyo (JP)

(72) Inventors: Hayato MORI, Tokyo (JP); Takashi INOUE, Tokyo (JP)

(21) Appl. No.: 16/899,732

(22) Filed: Jun. 12, 2020

(30) Foreign Application Priority Data
Aug. 9, 2019 (JP) 2019-147708

(51) Int. Cl. F24F 11/38; F24F 11/74; F24F 11/42; F24F 13/30

(52) U.S. Cl. CPC F24F 11/38; F24F 11/74; F24F 2110/12; F24F 13/30; F24F 11/42

(57) ABSTRACT

A refrigeration cycle system includes: an acquisition section configured to acquire external air information as information on at least one of an external air temperature around an outdoor unit or weather information; and a control section configured to control a rotation number of a fan of an air blower based on the external air information at a start of operation of the refrigeration cycle system.

### CROSS-REFERENCE TO RELATED APPLICATION

This application claims priority from Japanese Patent Application No. 2019-147708 filed with the Japan Patent Office on Aug. 9, 2019, the entire content of which is hereby incorporated by reference.

### BACKGROUND

### Technical Field

One aspect of the present disclosure relates to a refrigeration cycle system.

### Related Art

In an outdoor unit of an air-conditioning device, a fan might be damaged due to collision of a dropped icicle with the outdoor unit in the wintertime and collision of a foreign substance blown away by, e.g., a typhoon with the outdoor unit in the summertime. Moreover, even when the fan is not damaged, an unbalance state in which the center of gravity of the fan shifts from a rotary shaft might be caused due to adherence of snow or an ice block to the fan in the wintertime. When rotation is continued in this state, great vibration might be caused. If the worst happens, a heat exchanger and/or a pipe might be damaged. In this state, continuous operation of the air-conditioning device becomes impossible, and a great amount of time and cost is required for restoration. In a technique disclosed in JP-A-2014-211143, vibration of an air blower is detected by an acceleration sensor, and in this manner, an abnormality of the air blower is diagnosed.

### SUMMARY

A refrigeration cycle system includes: an acquisition section configured to acquire external air information as information on at least one of an external air temperature around an outdoor unit or weather information; and a control section configured to control a rotation number of a fan of an air blower based on the external air information at a start of operation of the refrigeration cycle system.

### BRIEF DESCRIPTION OF THE DRAWINGS

FIG. 1 is a schematic sectional view of an outdoor unit;

FIG. 2 is a schematic view of an air blower;

FIG. 3 illustrates a main configuration of a control equipment box;

FIG. 4 is a flowchart illustrating fan control processing;

FIG. 5 is a graph for describing low rotation control; and

FIG. 6 is a configuration diagram of an air-conditioning system according to a second embodiment.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the typical technique, it is difficult to sense the abnormality in a case where the operation of the air-conditioning device is not started. For this reason, there is a probability that damage becomes greater due to the start of the operation in a state with the abnormality.

The present disclosure has been made in view of such a problem. One object of the present disclosure is to suppress spreading of damage in a case where an abnormality has been caused.

A refrigeration cycle system according to an aspect of the present disclosure includes: an acquisition section configured to acquire external air information as information on at least one of an external air temperature around an outdoor unit or weather information; and a control section configured to control a rotation number of a fan of an air blower based on the external air information at a start of operation of the refrigeration cycle system.

A refrigeration cycle system according to another aspect of the present disclosure includes: a stress detection section configured to detect stress on a fan of an air blower in an axial direction; and a control section configured to control a rotation number of the fan based on the stress at a start of operation of the refrigeration cycle system.

According to the above-described aspects of the present disclosure, spreading of the damage can be suppressed in a case where the abnormality has been caused. Thus, a more highly-reliable refrigeration cycle system can be provided.

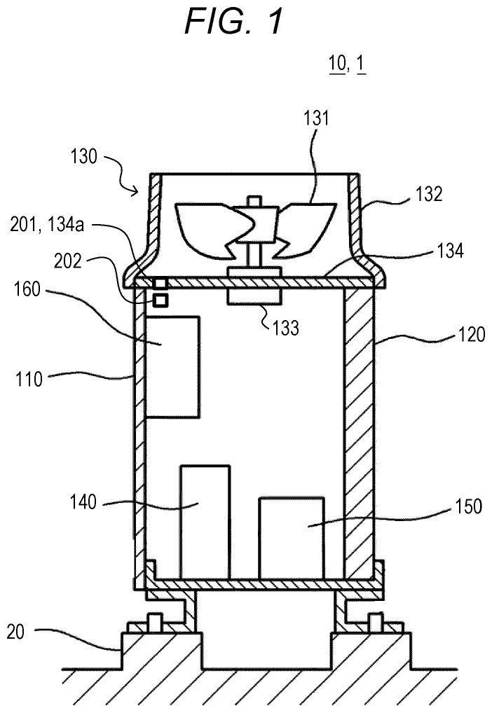

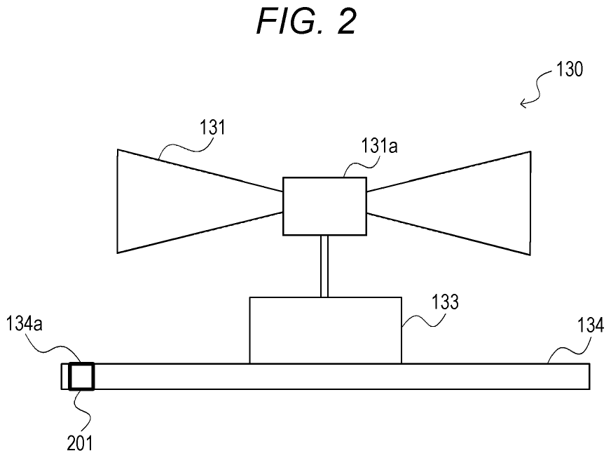

FIG. 1 is a schematic sectional view of an outdoor unit 10 of an air-conditioning system 1. FIG. 2 is a schematic view of an air blower 130 from a direction perpendicular to an axial direction of a fan 131. In the air-conditioning system 1 of the present embodiment, a refrigeration cycle is formed to perform air-conditioning in such a manner that the outdoor unit 10 and a not-shown indoor unit are connected to each other through a refrigerant pipe. The air-conditioning system 1 of the present embodiment is one example of a refrigeration cycle system.

As illustrated in FIG. 1, the outdoor unit 10 of the present embodiment is of an upward blowing type, and is placed on an outdoor base 20. A housing 110 of the outdoor unit 10 includes an air-cooling heat exchanger 120 and the air blower 130 configured to cause an air flow in the heat exchanger 120. The air blower 130 mainly has the fan (a propeller fan) 131, a shroud 132, a motor (a fan motor) 133, and a beam member 134. The shroud 132 is provided at the outer periphery of the fan 131, and functions as a bell mouth and a duct. The motor 133 drives the fan 131. The beam member 134 supports the motor 133.

As illustrated in FIGS. 1 and 2, a magnetic member 201 is provided at an end portion 134a of the beam member 134. The magnetic member 201 is a member made of a magnetic material. Moreover, a magnetic field sensor 202 configured to detect a magnetic field of the magnetic member 201 is provided below the magnetic member 201 in the vertical direction. The magnetic field sensor 202 is arranged at such a position that the magnetic field sensor 202 does not physically contact the magnetic member 201. In a case where snow or ice adheres to the fan 131 and a case where the fan 131 rotates, the beam member 134 bends downwardly in the vertical direction due to stress caused in these cases. Thus, a distance between the magnetic member 201 and the magnetic field sensor 202 changes. The magnetic field sensor 202 detects such displacement of the magnetic member 201. The magnetic field sensor 202 according to the present embodiment is formed from a hall element. The magnetic field sensor 202 detects a voltage generated according to a change in the distance between the magnetic field sensor 202 and the magnetic member 201 in association with bending of the beam member 134. The magnetic field sensor 202 can obtain, from the voltage, bending of the beam member 134, i.e., stress applied to the beam member 134.

The heat exchanger 120 is provided on a side surface of the housing 110. An external air temperature sensor 210 is provided in the vicinity of the heat exchanger 120. The external air temperature sensor 210 detects the temperature (an external air temperature) of air around the outdoor unit 10.

Moreover, as illustrated in FIG. 1, a compressor 140, an accumulator 150, a control equipment box 160 and the like are provided inside the housing 110. Information from various sensors such as the external air temperature sensor 210 and a pressure sensor for the refrigeration cycle forming the air-conditioning system 1 is input to the control equipment box 160. The control equipment box 160 houses, for example, a control section configured to control refrigeration cycle components such as the compressor 140 and an expansion valve (not shown) and an inverter device configured to control the air blower 130.

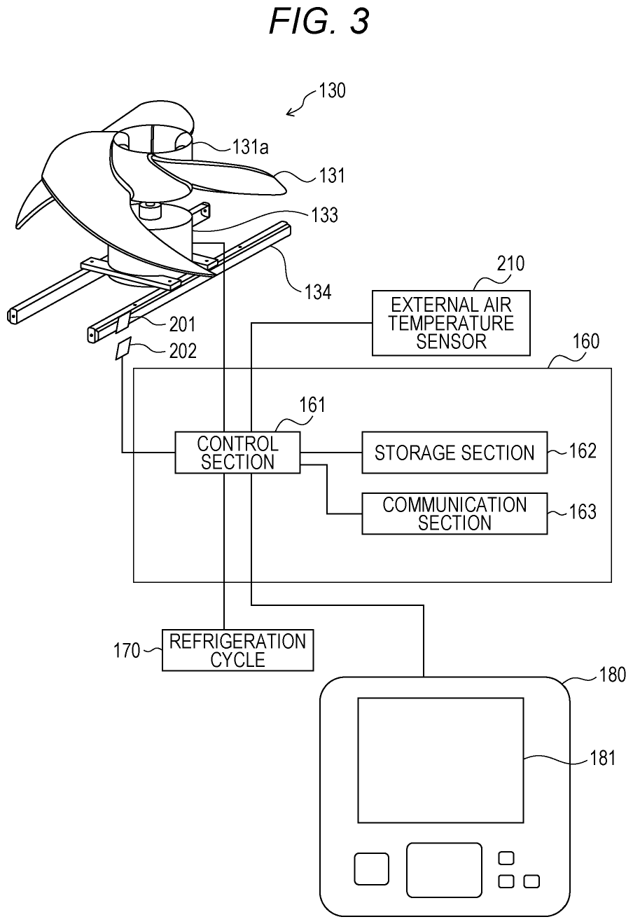

FIG. 3 illustrates a main configuration of the control equipment box 160. The control equipment box 160 is provided with a control section 161, a storage section 162, and a communication section 163. The control section 161 performs various types of control. The storage section 162 stores various programs and various types of information. The control section 161 executes the programs stored in the storage section 162 to perform various types of processing. The communication section 163 communicates with external equipment with or without a wire. The control section 161 controls, for example, a refrigeration cycle 170 having the compressor 140, the heat exchanger 120, the expansion valve or the like. Further, the control section 161 detects an abnormality of the fan 131. When detecting the abnormality, the control section 161 performs the control of displaying, on a display section 181 provided at a remote controller 180, notification information indicating that the abnormality has been detected.

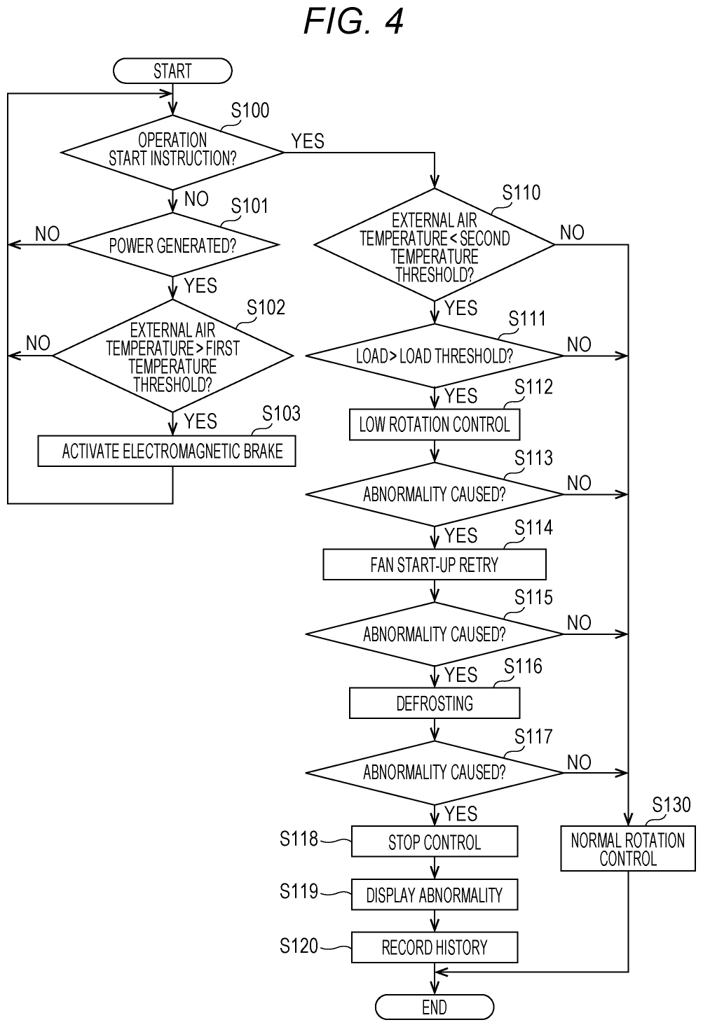

FIG. 4 is a flowchart showing fan control processing by the control section 161. Abnormality detection processing is the processing of detecting the abnormality of the fan 131. The abnormality of the fan 131 includes, for example, adherence of snow or ice to the fan 131. At S100, the control section 161 determines whether or not an instruction (an operation start instruction) for starting air-conditioning operation has been acquired. In a case where the operation start instruction has been acquired (YES at S100), the control section 161 proceeds the processing to S110. In a case where the operation start instruction is not acquired (NO at S100), the control section 161 proceeds the processing to S101.

At S101, the control section 161 determines whether or not the motor 133 generates power in accordance with rotation of the fan 131. Even in a state in which the control of rotating the fan 131 by the motor 133 is not performed, in a case where wind blows, the fan 131 rotates. When the fan 131 rotates, the motor 133 generates the power. That is, by power generation from the motor 133, it is recognized that wind blows. In a case where the motor 133 generates the power (YES at S101), the control section 161 proceeds the processing to S102. In a case where no power is generated (NO at S101), the control section 161 proceeds the processing to S100.

At S102, the control section 161 acquires the external air temperature from the external air temperature sensor 210. The external air temperature described herein is one example of external air information, and the processing at S102 is one example of the processing of acquiring the external air information. Then, the control section 161 compares the external air temperature and a preset first temperature threshold with each other. The first temperature threshold is a preset value. The processing at S101 and S102 is the processing of detecting that a typhoon has occurred. Thus, the first temperature threshold is a temperature in a season in which a typhoon occurs or a temperature lower than such a temperature.

In a case where the external air temperature is higher than the first temperature threshold (YES at S102), the control section 161 proceeds the processing to S103. In a case where the external air temperature is equal to or lower than the first temperature threshold (NO at S102), the control section 161 proceeds the processing to S100. At S103, the control section 161 performs the control of causing the motor 133 to serve as an electromagnetic brake by power generation from the motor 133 by rotation of the fan 131 to stop rotation of the fan 131. A reason why rotation of the fan 131 is stopped or the rotation number of the fan 131 is reduced is as follows. That is, the fan 131 has the upper limit of the rotation number in terms of design strength. When the rotation number of the fan 131 reaches an abnormally-high rotation number, there is a probability that excessive stress is caused on the fan 131 and the fan 131 itself is damaged. Note that likelihood is taken into consideration regarding allowable design stress of the fan 131. The above-described control is performed for reducing damage upon abnormally-strong wind in advance.

The above-described processing can reduce damage of the fan 131 in a case where the fan 131 rotates at high speed due to strong wind such as a typhoon in a state in which no control by the motor 133 is performed.

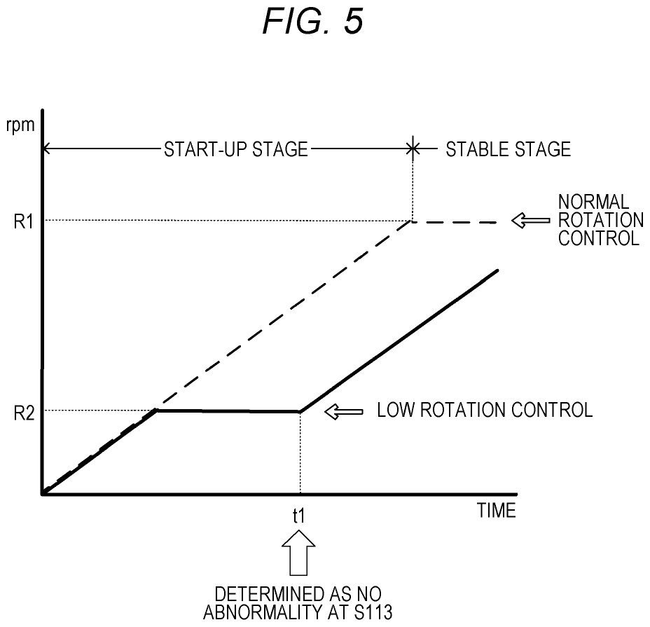

Next, processing after start-up will be described with reference to FIG. 5, as necessary. FIG. 5 illustrates one example of the profile of the rotation number (the rotation number per certain time, a rotation speed) in low rotation control. The horizontal axis of a graph illustrated in FIG. 5 indicates time, and the vertical axis indicates the rotation number. Moreover, a dashed line in the graph indicates the profile of control (normal rotation control) of the fan 131 in a normal state. A solid line indicates the profile in the low rotation control. The low rotation control will be described later.

First, at S110, the control section 161 acquires, after the start-up of the outdoor unit 10, the temperature, i.e., the external air temperature, from the external air temperature sensor 210. The external air temperature described herein is one example of the external air information. The processing at S110 is one example of the processing of acquiring the external air information. Then, the control section 161 compares the external air temperature and a preset second temperature threshold. The second temperature threshold described herein is a temperature at which ice or frost might adhere to the fan 131, such as −5° C. In a case where the external air temperature is lower than the second temperature threshold (YES at S110), the control section 161 proceeds the processing to S111. In a case where the external air temperature is equal to or higher than the second temperature threshold (NO at S110), the control section 161 proceeds the processing to S130.

At S130, the control section 161 performs the normal rotation control of the fan 131. The normal rotation control is control according to the profile indicated by the solid line in FIG. 5. The normal rotation control is the control of gradually increasing the rotation number until a rotation number R2. The rotation number R2 as described herein is a control value set from a set value of the air-conditioning operation. When the rotation number of the fan 131 reaches the rotation number R2 at a start-up stage, such a stage transitions to a stable stage.

At S111, the control section 161 determines whether or not a load on the beam member 134 is greater than a preset load threshold. Specifically, the control section 161 acquires a detection result of the magnetic field sensor 202, and in a case where the detection result is equal to or higher than a preset voltage threshold, determines that the load is greater than the load threshold. At the timing of the processing at S111, the fan 131 is stopped. Thus, the detection result of the magnetic field sensor 202 depends on the load on the beam member 134. In a case where ice or frost adheres to the fan 131, the weight of the fan 131 is greater than the weight of the fan 131 in the normal state. Thus, the beam member 134 more greatly bends, and the magnetic field sensor 202 detects a higher voltage. In a case where a voltage of equal to or higher than the threshold has been detected, the control section 161 determines that the load is greater than the threshold. As described above, the control section functions as a stress detection section. In a case where the load is greater than the load threshold (YES at S111), the control section 161 proceeds the processing to S112. In a case where the load is equal to or less than the load threshold (NO at S111), the control section 161 proceeds the processing to S130.

At S112, the control section 161 performs the low rotation control of the fan 131. As illustrated in FIG. 5, in the low rotation control, the control section 161 gradually increases the rotation number in a range up to the maximum rotation number (R2 in FIG. 5) in the low rotation control. The maximum rotation number (R2) as described herein is a value smaller than the maximum rotation number (R1 in FIG. 5) upon the start-up in the normal control, and is set in advance. The maximum rotation number R2 is, for example, preferably set to a value of less than 100 rpm. Moreover, the profiles of the maximum rotation number and a rotation number change in the low rotation control are set in advance.

Note that the maximum rotation number (R1) upon the start-up in the normal control is one example of a first rotation number set according to the set value of the air-conditioning operation, and the maximum rotation number (R2) in the low rotation control is one example of a second rotation number less than the first rotation number.

Note that in the control example illustrated in FIG. 5, an acceleration up to the maximum rotation number in the low rotation control is equal to the acceleration of the rotation number in the normal rotation control. On this point, the acceleration up to the maximum rotation number in the low rotation control may be lower than the acceleration of the rotation number in the normal rotation control.

When predetermined time has elapsed after the start of the low rotation control, the control section 161 determines, at S113, whether or not the abnormality has been caused at the fan 131. As described above, the control section 161 functions as an abnormality detection section. The control section 161 of the present embodiment detects the abnormality of the fan 131 according to the degree of bending of the beam member 134, i.e., the stress on the beam member 134. Hereinafter, the processing of detecting the abnormality will be described. During rotation of the fan 131, the stress corresponding to the rotation number of the fan 131 is on the beam member 134. On the other hand, in a case where the abnormality has been caused at the fan 131, a greater stress than that in the normal state is on the beam member 134 due to vibration of the fan 131 caused by shift of the center of gravity of the fan 131. Further, in the normal state, the stress increases as the rotation number increases.

For this reason, the outdoor unit 10 of the present embodiment stores a relational expression between the rotation number and a reference voltage in the storage section 162 in advance. Note that as another example, a correspondence table between the rotation number and the reference voltage may be stored in the storage section 162. Then, from a comparison result between the reference voltage and the voltage detected by the magnetic field sensor 202, the control section 161 detects the presence/absence of the abnormality at the fan 131. Specifically, the control section 161 obtains the reference voltage from the rotation number, and compares the reference voltage and the voltage actually sensed by the magnetic field sensor 202 with each other. Then, in a case where the sensed voltage is higher than the reference voltage, the control section 161 determines that the abnormality has been caused at the fan 131. On the other hand, in a case where the sensed voltage is equal to or lower than the reference voltage, the control section 161 determines that no abnormality is caused at the fan 131.

Returning to FIG. 4, in a case where the abnormality has been caused at the fan 131 (YES at S113), the control section 161 proceeds the processing to S114. In a case where no abnormality is caused (NO at S113), the control section 161 proceeds the processing to S130.

Suppose that as illustrated in FIG. 5, S113 is performed and it is determined (evaluated) as no abnormality at timing tl. In this case, at S130, the normal rotation control is performed. That is, the rotation control of the fan 131 transitions from the low rotation control to the normal rotation control. Thus, as illustrated in FIG. 5, the control of increasing the rotation number of the fan 131 to a greater rotation number than the maximum rotation number in the low rotation control.

For example, there is a case where ice or frost adheres to the fan 131 while the outdoor unit 10 is stopped. In such a state, when the fan 131 is rotated, vibration might be caused at the fan 131, leading to, e.g., damage of the heat exchanger 120. On the other hand, the control section 161 of the present embodiment determines, by the processing at S111 and S112, whether or not there is a probability that the abnormality has been caused at the fan 131. Then, in a case where there is a probability that the abnormality has been caused, the control section 161 performs, at the start of operation, the low rotation control as control with a smaller rotation number than that in the normal rotation control. Thus, damage such as damage of the heat exchanger 120 can be reduced. Further, the control section 161 performs detection of the abnormality during the low rotation control. Thus, in a case where the abnormality has been caused, a proper step can be taken. In addition, in a case where no abnormality is detected, the control section 161 causes the control to transition from the low rotation control to the normal rotation control. Thus, the air-conditioning operation corresponding to the set value of the air-conditioning operation can be promptly started.

Returning to FIG. 4, the control section 161 stops, at S114, rotation of the fan 131, starts up the fan 131 again, and performs the low rotation control again. In a case where a relatively small amount of frost or ice adheres to the fan 131, the frost or the ice can be dropped from the fan 131 when rotation of the fan 131 is stopped.

Then, when predetermined time has elapsed after the re-start, the control section 161 determines, at S115, the presence/absence of the abnormality of the fan 131. In a case where the abnormality has been caused (YES at S114), the control section 161 proceeds the processing to S116. In a case where no abnormality is caused (NO at S114), the control section 161 proceeds the processing to S130.

At S116, the control section 161 performs the defrosting processing of melting ice or frost on the fan 131. Specifically, the control section 161 melts frost or ice in such a manner that the heat exchanger 120 operates as a condenser to send hot air to the fan 131. In this defrosting processing, even in a case where a relatively great amount of frost or ice adheres to the fan 131, such frost or ice can be removed. That is, in this defrosting processing, frost or ice which could not be removed in fan start-up retry processing (S114) can be removed. When predetermined time has elapsed after the start of the defrosting processing, the control section 161 re-determines, at S117, the presence/absence of the abnormality of the fan 131. In a case where the abnormality has been caused (YES at S117), the control section 161 proceeds the processing to S118. In a case where no abnormality is caused (NO at S117), the control section 161 proceeds the processing to S130. Note that the abnormality detection processing at S115 and S117 is similar to the abnormality detection processing at S113.

At S118, the control section 161 stops the air-conditioning operation. That is, the control section 161 stops rotation of the fan 131. Next, at S119, the control section 161 displays, on the display section 181, an indication that the abnormality has been caused. Further, at S120, in the storage section 162, the control section 161 records, as a history, the indication that the abnormality has been caused. Then, the fan control processing ends.

As described above, in the air-conditioning system 1 according to the present embodiment, the low rotation control of the fan 131 is performed at the start of the air-conditioning operation. Thus, even in a case where the abnormality has been caused at the fan 131, spreading of damage such as damage of peripheral components due to rotation of the fan 131 can be suppressed. Consequently, a more highly-reliable refrigeration cycle system can be provided.

A first variation of the present embodiment will be described. A condition for performing the low rotation control is not limited to the condition described in the embodiment. The control section 161 may perform the low rotation control in a case where an external air condition which might lead to the abnormality is satisfied. For example, the control section 161 may be configured to skip the processing of S111 and perform, in a case where the external air temperature is lower than the threshold, the low rotation control regardless of the load on the beam member 134. Moreover, as another example, the control section 161 may be configured to perform the low rotation control in a case where the load on the beam member 134 is greater than the load in the normal state. That is, the control section 161 may be configured to skip the processing of S110 and perform the low rotation control in a case where the load on the beam member 134 is greater than the load threshold.

A second variation will be described. At S110, it is enough to determine whether or not external air is in a status in which frost or ice might adhere to the fan 131. Specific processing for such determination is not limited to the processing described in the embodiment. For example, the control section 161 acquires weather information such as weather forecasting from an external device via the communication section 163. Further, a weather information condition corresponding to the external air in the status in which frost or ice might adhere to the fan 131 is stored in advance in the storage section 162. Such a weather information condition includes, for example, a condition where the weather is snowing and a condition where the temperature is below zero. The control section 161 may be configured to proceed the processing to S111 in a case where the weather information acquired from the external device satisfies the condition stored in the storage section 162. As described above, the control section 161 may acquire, as the external air information, at least one of the external air temperature around the outdoor unit of the refrigeration cycle system or the weather information, and based on the acquired external air information, may control the rotation number of the fan 131 of the air blower 130.

Similarly, at S102, it is enough to determine whether or not the status of external air is in a status in which a typhoon might occur. Specific processing for such determination is not limited to the processing described in the embodiment. For example, the control section 161 may determine, based on the weather information, whether or not a typhoon has occurred. Then, in a case where the typhoon has occurred, the control section 161 may activate the electromagnetic brake.

In a third variation, the control section 161 may perform the low rotation control in a case where a condition (a stress condition) for such stress that the abnormality might be caused is satisfied. The stress condition for performing the low rotation control is not limited to the condition described in the embodiment. For example, the control section 161 may be configured to perform the low rotation control in a case where the stress is lower than a stress threshold. Thus, the low rotation control can be performed in a case where the abnormality such as a defect of part of the fan 131 has been caused.

In a fourth variation, the processing in a case where the abnormality has been detected in the low rotation control is not limited to that in the example described in the embodiment. In another example, the control section 161 may be configured to stop the fan 131 without performing the fan start-up retry processing (S114) and the defrosting processing (S116) in a case where the abnormality has been detected at S113.

A fifth variation will be described. The control section 161 may detect the abnormality based on vibration of the fan 131. Specific processing of detecting the abnormality is not limited to that in the example described in the embodiment. For example, an acceleration sensor (not shown) configured to detect the acceleration of the fan 131 may be provided at, e.g., the air blower 130. In this case, the control section 161 may determine the presence/absence of the abnormality based on a result of detection of the acceleration of the fan 131 by the acceleration sensor.

Moreover, in another example, a magnetic member is provided at a predetermined position of a shaft of the fan 131 in the outdoor unit 10, and a magnetic field sensor is placed at a position farther from the shaft than the magnetic member. The control section 161 may determine the presence/absence of the abnormality based on the detection result of the magnetic field sensor regarding the magnetic member during rotation of the fan 131. In a case where the fan 131 normally rotates, the fan 131 rotates at a constant speed. Thus, the cycle of a change in a distance between the magnetic member and the magnetic field sensor is constant, and the cycle of detection of the magnetic field sensor is also a constant value. However, in a case where the abnormality such as a defect of the fan 131 has been caused, the position of the center of gravity of the fan 131 shifts, and vibration is caused at the fan 131. For this reason, the cycle of the change in the distance between the magnetic member and the magnetic field sensor is disrupted. As a result, the cycle of detection of the magnetic field sensor is a value shifted from the constant value. The control section 161 can determine the presence/absence of vibration of the fan 131, i.e., the abnormality of the fan 131, based on the detection cycle obtained corresponding to the magnetic member, which is provided at the shaft of the fan 131, by the magnetic field sensor.

Further, in another example, the outdoor unit 10 may include, as a configuration for abnormality detection, a strain gauge instead of the magnetic member 201 and the magnetic field sensor 202. The strain gauge is provided at the beam member 134. The strain gauge is preferably arranged at the end portion 134a of the beam member 134. In this case, the control section 161 may acquire a strain detected by the strain gauge, and may perform the abnormality detection processing by means of stress corresponding to the strain.

In a sixth variation, in the present embodiment, the air-conditioning system has been described as one example of the refrigeration cycle system including the fan of the air blower. On this point, the refrigeration cycle system including the fan of the air blower according to the aspect of the present disclosure may be a refrigeration system.

In a seventh variation, a subject of the abnormality detection processing described with reference to FIG. 4 is not limited to the control section 161 of the outdoor unit 10, and may be other members. In another example, a control section of the not-shown indoor unit may execute the abnormality detection processing. In a case where the outdoor unit 10 is managed by a central control device configured to manage multiple outdoor units and multiple air-conditioning devices, the air-conditioning system may be configured to execute the abnormality detection processing by the central control device.

### Second Embodiment

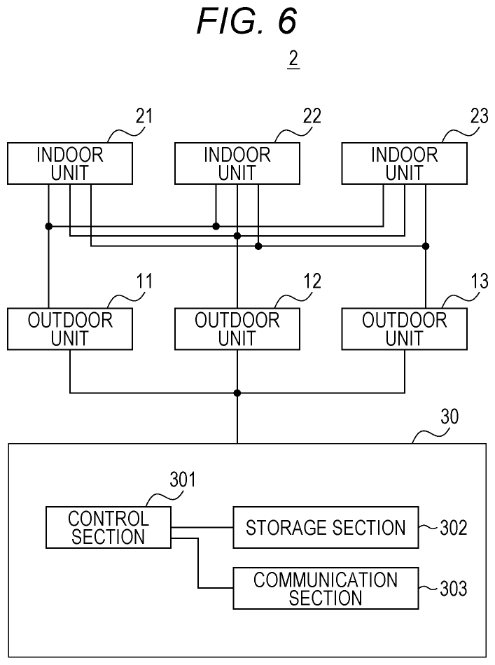

Next, an air-conditioning system according to a second embodiment will be described. FIG. 6 is an entire configuration diagram of the air-conditioning system 2 according to the second embodiment. The air-conditioning system 2 includes multiple outdoor units 11, 12, 13 and multiple indoor units 21, 22, 23. Further, the air-conditioning system 2 includes a central control device 30 configured to manage these types of equipment.

The central control device 30 includes a control section 301, a storage section 302, and a communication section 303. The control section 301, the storage section 302, and the communication section 303 each have functions similar to those of the control section 161, the storage section 162, and the communication section 163 of the control equipment box 160. The control section 301 controls the outdoor units 11 to 13 and the indoor units 21 to 23. Further, the control section 301 performs, for each of the outdoor units 11 to 13, the fan control processing (see FIG. 4) described in the first embodiment. Then, in a case where an abnormality has been detected at S117, rotation of a fan 131 of the outdoor unit for which the abnormality has been detected is stopped, and air-conditioning operation by other outdoor units is continued. With this configuration, the air-conditioning system 2 can safely start the air-conditioning operation by the outdoor units with no abnormality while stopping operation of the outdoor unit with the abnormality.

Note that the present disclosure is not limited to the above-described specific embodiment. For the above-described embodiment, various modifications and changes such as application of a variation of a certain embodiment to other embodiments can be made within the scope of the gist of the technique of the present disclosure described in the claims.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A refrigeration cycle system comprising:
an acquisition section configured to acquire external air information as information on at least one of an external air temperature around an outdoor unit or weather information; and
a control section configured to control a rotation number of a fan of an air blower based on the external air information at a start of operation of the refrigeration cycle system.

2. The refrigeration cycle system according to claim 1, wherein
at the start of the operation, the control section sets the rotation number of the fan to a second rotation number less than a first rotation number set according to a set value of the operation in a case where the external air information satisfies a preset external air condition.

3. The refrigeration cycle system according to claim 2, further comprising:
a stress detection section configured to detect stress on the fan in an axial direction,
wherein the control section sets the rotation number of the fan to the second rotation number in a case where the external air information satisfies the external air condition and the stress satisfies a preset stress condition.

4. The refrigeration cycle system according to claim 2, further comprising:
an abnormality detection section configured to detect an abnormality of the fan when the rotation number of the fan is set to the second rotation number.

5. The refrigeration cycle system according to claim 4, wherein
the control section stops rotation of the fan in a case where the abnormality of the fan has been detected.

6. The refrigeration cycle system according to claim 4, wherein
the control section performs defrosting processing for a heat exchanger in the case where the abnormality of the fan has been detected.

7. The refrigeration cycle system according to claim 1, wherein
the control section activates, according to the external air information, an electromagnetic brake configured to stop rotation of the fan, the rotation being made not with power of a motor during stop of the refrigeration cycle system.

8. The refrigeration cycle system according to claim 1, wherein
the outdoor unit includes multiple outdoor units,
an abnormality detection unit configured to detect an abnormality of a fan of each outdoor unit while the control section is controlling the rotation number of the fan of the air blower is further provided, and
in a case where the abnormality has been detected at one of the multiple outdoor units, the control section stops rotation of the fan of the one of the multiple units for which the abnormality has been detected.

9. A refrigeration cycle system comprising:
a stress detection section configured to detect stress on a fan of an air blower in an axial direction; and
a control section configured to control a rotation number of the fan based on the stress at a start of operation of the refrigeration cycle system.

10. The refrigeration cycle system according to claim 9, wherein
at the start of the operation, the control section sets the rotation number of the fan to a second rotation number less than a first rotation number set according to a set value of the operation in a case where the stress satisfies a preset stress condition.
